(19) United States
(12) Patent Application Publication
(10) Pub. No.: US 2004/0088577 A1
(43) Pub. Date: May 6, 2004

(54) System and method for evaluating internet and intranet information

(75) Inventor: Kenneth J. Render, West Richland, WA (US)

Correspondence Address: Michael A. Kerr, Ste. 211, 777 E. William St., Carson City, NV, 89701, US

(73) Assignee: Battelle Memorial Institute, a corporation of Ohio, Richland, WA

(21) Appl. No.: 10/286,339

(22) Filed: Oct. 31, 2002

(51) Int. Cl. G06F 11/30

(52) U.S. Cl. 713/201

(57) ABSTRACT

The invention relates to an apparatus and method for evaluating security threats from information available on the Internet or an Intranet. The method comprises gathering information from the Internet or an Intranet using at least one analyst defined parameter. The method then proceeds to generate a visual display of the gathered information. After generating the visual display of the information, the method provides a plurality of software tools for analyzing the visual display and the gathered information to identify a potential security threat. The method then generates an automated report based on the gathered information, the visual display, and the security threat analysis.

### BACKGROUND

1. Field

The present system and method are related to the evaluation of information stored in information systems. More particularly, the system and method provide for the gathering, visualizing and analyzing information.

2. Description of Related Art

Security experts agree that the Internet can be used to obtain, correlate, and evaluate an unprecedented volume of aggregated information on business, government and private activities. Nowhere is the potential danger of this more clean than in a January 2002 threat advisory from the FBI which stated terrorists may be using U.S. web sites to obtain information regarding local energy infrastructures, water reservoirs, dams, highly-enriched uranium storage sites, and nuclear and gas facilities.

Procedures have been developed to evaluate security concerns with Internet information and Intranet information. These procedures are described in the “Operations Security Internet Presence Assessment Guide” (referred to as the “Guide”) which was published in 1998 and updated in 2001. The Guide, which is hereby incorporated by reference, describes a “security assessment” which is a procedure that is used to determine if there is sufficient information on Internet web pages to compromise sensitive, proprietary, or classified activities or support adversarial targeting of individuals and programs.

Although the procedures described in the Guide have been effectively used by the intelligence community, there are a variety of limitations to these written procedures. One significant limitation with these written procedures is that substantial resources must be allocated to analyst training. Additionally, to implement the procedures in the Guide, an analyst must have operations security experience, a working understanding of the Internet's structure and operation, and a working familiarity with Internet browser software. Another limitation with the written procedures is the need to use an “assessment team” to implement the written procedures described in the Guide. The assessment team approach is necessary due to the unique challenges of searching large volumes of information from multiple web sites and web pages, as well as newsgroups and FTP sites.

Another limitation with the existing written procedures is related to the collection of Internet information. For example, there is a need for a coordinated team approach to identify the desired search terms to apply to the various Internet protocols such as the hypertext transfer protocol (HTTP), file transfer protocol (FTP), and the network news transfer protocol (NNTP).

Yet another limitation associated with the written procedures is that they do not provide a simple method for performing specialized searches. Specialized searches include backwards navigation, and reverse web searching.

Once the Internet information has been collected, the Guide calls for the analysis of the collected Internet Information and the generation of an Assessment Report. The analysis of data includes identifying the approximate number of web pages reviewed, identifying the locations for the Internet information, and identifying web pages that raise security concerns. Once the analysis is completed, then an Assessment Report is prepared. The Assessment Report includes a listing of the search terms, a listing of the searches completed and of the analysis that was performed. Regretfully, by the time the analysis and Assessment Report is completed, the collected Internet information will have changed.

It shall be appreciated by security analysts having ordinary skill in the art that there are a variety of limitations associated with applying the procedures described by the Guide. Therefore, there is a need for a system and method which can overcome the limitations described above. A plurality of embodiments that can overcome the limitations described above and which can also provide new and additional benefits are described in further detail below.

### SUMMARY

An apparatus and method for evaluating security threats from information available on the Internet or an Intranet is described. The method comprises gathering information from the Internet or an Intranet using at least one analyst defined parameter. The method then proceeds to generate a visual display of the gathered information. After generating the visual display of the information, the method provides a plurality of software tools for analyzing the visual display and the gathered information to identify a potential security threat. The method then generates an automated report based on the gathered information, the visual display, and the security threat analysis.

There are at least two types of searches that can be performed by the system and method of the present invention. The first type of search is referred to as a web domain or facility based approach. In the web domain approach, the analyst defined parameter is a Uniform Resource Locator (URL) address that corresponds to a target domain, a web site or a set of web locations. The second type of search is referred to as a topical or programmatic approach. In the topical approach the analyst defined parameter includes a search string related to a topic that is collected from web pages concerning the target topic. In both types of searches, the information gathered from the Internet or the Intranet includes at least one web page, at least one posting from a newsgroup and a at least one piece of broadcast e-mail. Additionally, the method permits the analyst to perform stealth searches while gathering information.

Information is gathered from the Internet or the Intranet using at least one search engine. To expand the amount of information gathered, the method permits backwards navigation for the topical search string approach. To limit the amount of information gathered from the Internet, performs a refined search as described above. The method also identifies the gathered information having limited or restricted access.

As information is being gathered, a plurality of out-bound hyperlinks and a plurality of in-bound hyperlinks are identified. During the analysis of the gathered information, statistical analysis is performed with the plurality of out-bound hyperlinks and the plurality of in-bound hyperlinks. The out-bound hyperlinks and in-bound hyperlinks are also used to generate a visual display which is a three-dimensional graphical layout that is typically color coded.

The method of the present invention includes storing the gathered information in a database. In a first embodiment, any subsequent changes to the gathered information are also stored in the database. Additionally, in the first embodiment, changes to the database are identified for further analysis. Furthermore, the changes to the database may also be analyzed on a real-time basis and a historical analysis of changes to the gathered information can be performed.

During the analysis of the visual display and the gathered information, the method permits the analyst to perform a refined search of the gathered information to identify a subset of the gathered information. After identifying the subset of gathered information, the method then proceeds to analyze the subset of information. During the performance of the refined search the analyst can provide another URL or another search string.

### BRIEF DESCRIPTION OF THE DRAWINGS

Preferred embodiments are shown in the accompanying drawings wherein:

FIG. 1 shows an illustrative general purpose computer configured to apply the methods described.

FIG. 2 shows an illustrative client-server system configured to apply the methods described.

FIG. 3 shows a high level flowchart of the method for evaluating Internet and Intranet information for security purposes.

FIG. 4 shows a more detailed flowchart of the process for determining the type of search to perform.

FIG. 5 shows a more detailed flowchart of process for gathering information from the Internet or an Intranet.

FIG. 6 shows a more detailed flowchart of the visualization process and the analysis process.

FIG. 7 shows an illustrative user interface.

FIG. 8 shows an illustrative hyperlink topographic layout.

FIG. 9 shows a more detailed flowchart of information that may be included in an illustrative search report.

### DETAILED DESCRIPTION

In the following detailed description, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

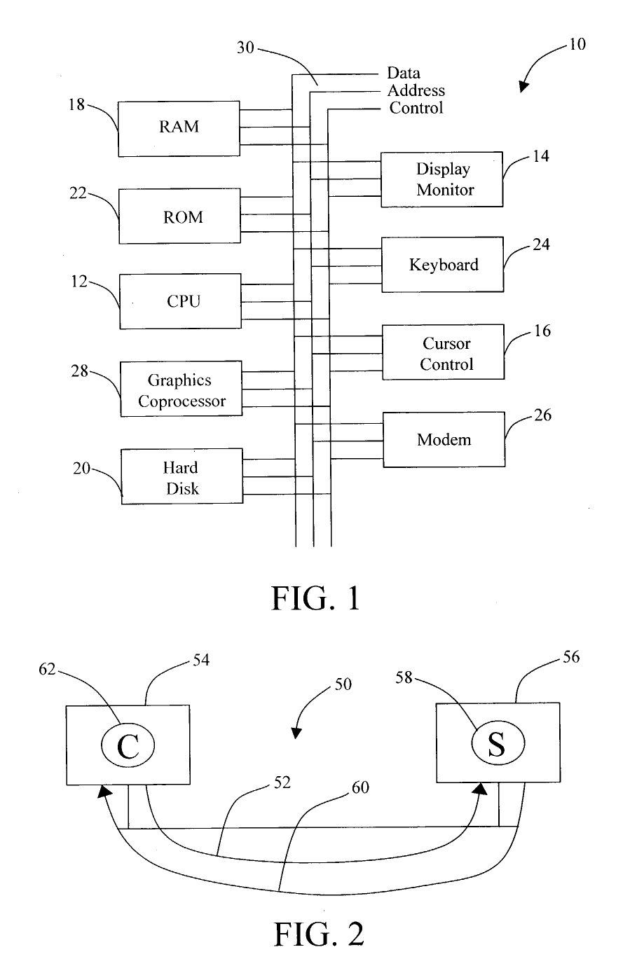

Referring to FIG. 1 there is shown an illustrative general purpose computer 10 suitable for implementing the methods described herein. The general purpose computer 10 includes at least one central processing unit (CPU) 12, a display monitor 14, and a cursor control device 16. The cursor control device 16 can be implemented as a mouse, a joy tick, a series of buttons, or any other input device which allows user to control position of a cursor or pointer on the display monitor 14. The general purpose computer may also include random access memory 18, external storage 20, ROM memory 22, a keyboard 24, a modem 26 and a graphic co-processor 28. All of the elements of the general purpose computer 10 may be tied together by a common bus 30 for transporting data between the various elements.

The bus 30 typically includes data, address, and control signals. Although the general purpose computer 10 illustrated in FIG. 1 includes a single data bus 30 which ties together all of the elements of the general purpose computer 10, there is not requirement that there be a single communication bus which connects the various elements of the general purpose computer 10. For example, the CPU 12, RAM 18, ROM 22, and graphics co-processor might be tied together with a data bus while the hard disk 20, modem 26, keyboard 24, display monitor 14, and cursor control device are connected together with a second data bus (not shown). In this case, the first data bus 30 and the second data bus (not shown) could be linked by a bi-directional bus interface (not shown). Alternatively, some of the elements, such as the CPU 12 and the graphics co-processor 28 could be connected to both the first data bus 30 and the second data bus (not shown) and communication between the first and second data bus would occur through the CPU 12 and the graphics co-processor 28. The methods of the present invention are thus executable on any general purpose computing architecture such as the 10 illustrated in FIG. 1, but there is no limitation that this architecture is the only one which can execute the methods of the present invention.

Alternatively, the methods of the invention can be implemented in a client/server architecture which is shown in FIG. 2. It shall be appreciated by those of ordinary skill in the art that a client/server architecture 50 can be configured to perform similar functions as those performed by the general purpose computer 10. In the client-server architecture communication generally takes the form of a request message 52 from a client 54 to the server 56 asking for the server 56 to perform a server process 58. The server 56 performs the server process 58 and send back a reply 60 to a client process 62 resident within client 54. Additional benefits from use of a client/server architecture include the ability to store and share gathered information and to collectively analyze gathered information between a team in which each member has access to a client 54. In another alternative embodiment, a peer-to-peer network (not shown) can used to implement the methods of the invention.

In operation, the general purpose computer 10, client/server network system 50, and peer-to-peer network system execute a sequence of machine-readable instructions. These machine readable instructions may reside in various types of signal bearing media. In this respect, one aspect of the present invention concerns a programmed product, comprising signal-bearing media tangibly embodying a program of machine-readable instructions executable by a digital data processor such as the CPU 12 for the general purpose computer 10.

It shall be appreciated by those of ordinary skill that the signal-bearing media may comprise, for example, RAM 18 contained within the general purpose computer 10 or within a server 56. Alternatively the instructions may be contained in another signal-bearing media, such as a magnetic data storage diskette that is directly accessible by the general purpose computer 10 or the server. 56. Whether contained in the general purpose computer or in the server, the machine readable instruction may be stored in a variety of machine readable data storage media, such as a conventional “hard drive” or a RAID array, magnetic tape, electronic read-only memory (ROM), an optical storage device such as CD-ROM, or other suitable signal bearing media including transmission media such as digital and analog and communication links. In an illustrative embodiment, the machine-readable instructions may comprise software object code, compiled from a programming language such as C++ or Java.

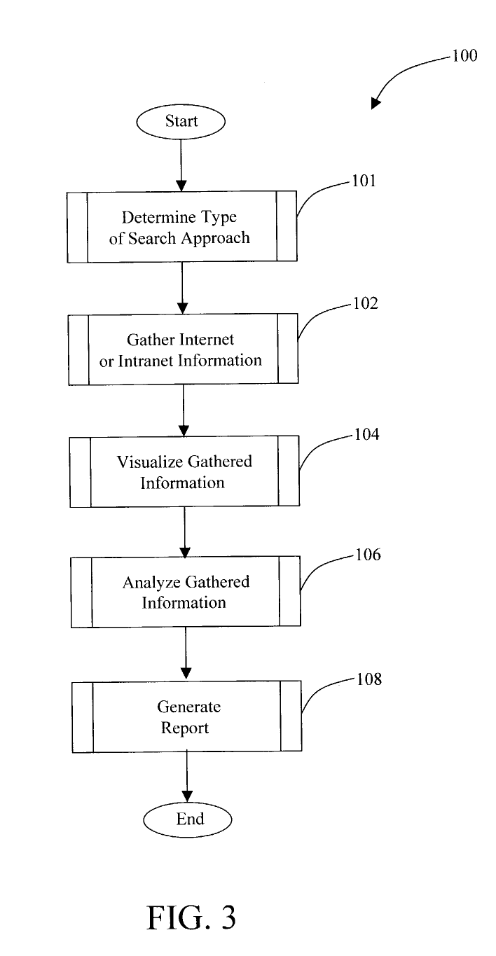

Referring to FIG. 3 there is shown a high level flow chart of the method for evaluating Internet and Intranet information. The methods described in the remaining Figures are executed as machine readable instructions in the general purpose computer 10 or in the networked environment described above. The method 100 identifies “sensitive” information available on the Internet or an Intranet. Sensitive information is any individual piece of information or aggregated grouping of information that can be accessed by a party that poses a security threat. In one embodiment, the unauthorized party uses the sensitive information to identify weakness that pose a national security threat. In another embodiment, the unauthorized party poses a threat to the trade secrets of an organization or corporation.

By way of example and not of limitation, the method 100 may be applied to gathering information from web sites, newsgroups, and from broadcast mail. Additionally, the method can be applied to gathering information from File Transfer Protocol (FTP) sites, from instant messaging applications, and other such Internet applications.

The method 100 is initiated at process block 101 in which an analyst determines the type of search approach to use to identify sensitive information. One search approach is the web domain approach in which the analyst defined parameter is a Uniform Resource Locator (URL) address that corresponds to a targeted portion of the Internet or an Intranet. The other approach is referred to as the “topical approach”. In the topical approach the analyst defined parameter includes a search string related to a topic that is used to gather information from the Internet or an Intranet.

The method then proceeds to process block 102 where information is gathered from the Internet or an Intranet. The process of gathering information from the Internet or the Intranet includes receiving at least one analyst defined parameter. The analyst defined parameter is either a search string (topical search) provided by the analyst or a location on the Internet (URL type approach). The gathering of Internet and Intranet information is performed by using the analyst defined parameter to search for information communicated using various Internet protocols. It shall be appreciated by those of ordinary skill in the art having the benefit of this disclosure that the protocols identified in this description are illustrative and are not intended to limit the scope of the claims.

By way of example and not of limitation, one way of accessing information on the Internet uses the World Wide Web, or simply “Web”. The Web employs the HyperText Transfer Protocol (HTTP) to transmit data across the Internet. HTTP defines how messages are formatted and transmitted, and the actions that Web servers and browsers should take in response to various commands. The Web also utilizes browsers, such as Internet Explorer or Netscape, to access Web documents called “web pages” that are linked to each other via hyperlinks. Web documents may also contain graphics, sounds, text and video.

The HTTP protocol used by the Web is one of many protocols employed by the Internet to transmit data. Another well-known Internet protocol used to communicate e-mail messages is the Simple Mail Transfer Protocol (SMTP). Usenet newsgroups use the Network News Transport Protocol (NNTP) to transfer information on the Internet. The File Transfer Protocol (FTP) is used to transfer files on the Internet. A variety of different protocols are used for instant messaging type applications. The process 102 also permits for the gathering of Internet information that is communicated using other Internet protocols.

An Intranet is a network that typically uses some of the Internet protocols such as the Transmission Control Protocol/Internet Protocol (TCP/IP) to communicate information. The information on an Intranet belongs to an organization and is accessible only to organization's members, employees, or others with authorization. Typically, the Intranet's web sites look and act just like an Internet web sites, however a firewall surrounding the Intranet fends off unauthorized access.

The method then proceeds to process block 104 in which an image is generated that permits the analyst to visualize the gathered Internet or Intranet information. As shown in FIG. 3, the visualization of the gathered information is performed after gathering the Internet or Intranet information.

The method then proceeds to process block 106 in which a plurality of software tools are used to analyze the gathered information from process block 102 and the visual display from process block 104. In one illustrative embodiment, the analysis is performed with a user friendly graphical user interface (GUI). During the analysis performed in process block 106, the determination is made whether sensitive information is available to an unauthorized party and whether there is a potential security threat.

At the analyst's option, a report is then generated at process block 108. In one embodiment, the report is an automated report that identifies the type of search, the search terms used, the gathered information, and the results of the analysis. A more detailed description of a reporting method is provided below.

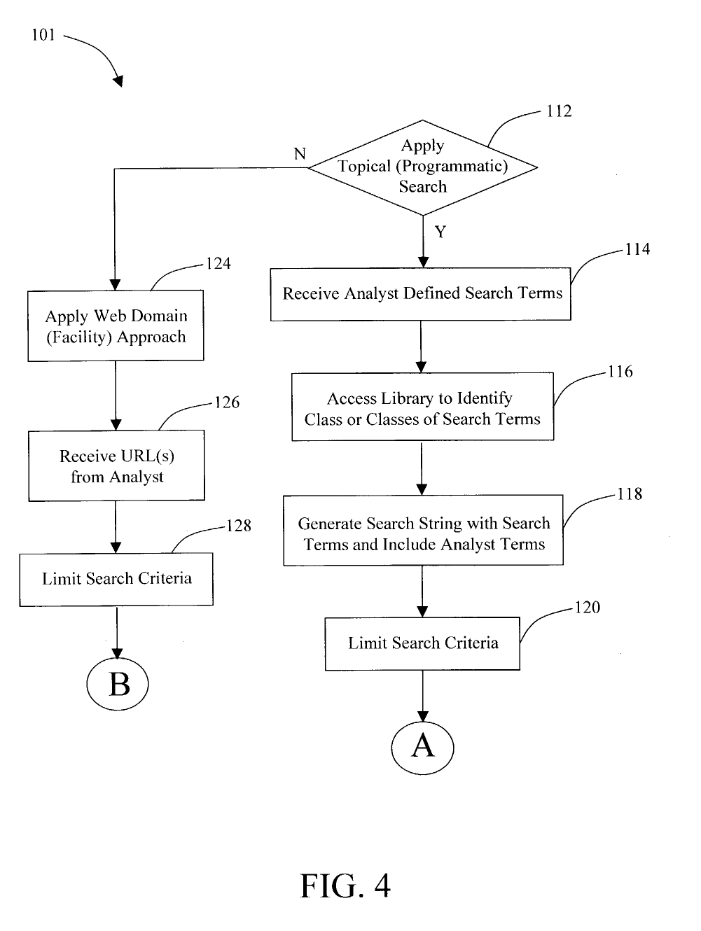

Referring to FIG. 4 there is shown a more detailed view of the process for determining the type of Internet search to perform. The process for gathering information from the Internet or the Intranet is initiated by having the analyst make the determination of whether to perform a URL address search approach or a topical search. For purposes of this disclosure, the illustrative embodiment of the URL address search looks to the Web and is also referred to as the web domain approach. If the analyst decides at decision diamond 112 to perform a topical search, the method then proceeds to process block 114. In process block 114, the analyst defined parameter includes a search string related to a topic.

The method then proceeds to process block 116 in which the search string is used to access a library. In an illustrative embodiment, the library is stored in the general purpose computer 10 or in the server 56. The library is divided into a plurality of different classes in which each class in comprised of a plurality of search terms. In process block 116 the analyst search terms are used to determine which class or classes of search terms are to be used during the information gathering process. Once the appropriate class or classes are determined, then a search string is generated as described by process block 118. The search string generated in process block 118 includes the search terms from the selected class or classes and any additional terms that may be provided separately by the analyst.

In an alternative embodiment, the processes described in block 116 and 118 are combined so that the analyst simply provides at least one analyst define search term and the method generates a plurality of corresponding search terms. The analyst can then sift through the library's search terms and select appropriate search terms, delete inapplicable search terms, and insert the analyst's own search terms.

Due to the volume of information available from the Internet and the number of search terms that are generated for a search, there is likely a need to limit the search criteria as described in process block 120. There are a variety of methods that can be used to limit analyst searches. These methods include using limiting search criteria such as putting a minus “−” sign in front of a search term, or performing domain restrictions. By way of example and not of limitation, domain restrictions for a topical search include limiting information to .gov or .mil domains.

In operation, the process steps 114 to 120 can be applied to a variety of different industries concerned about disseminating information that may pose a security threat. In an illustrative example, a U.S. electrical power utility company is concerned about disseminating sensitive information through their web site. The utility company retains an analyst to determine if sensitive information is being made publicly available through the Web. Note, that the scope of the search could easily have been expanded as described above, however, for illustrative purposes the search criteria is confined to the Web. The analyst goal is to ensure that information that is publicly available on the Web does not pose a security risk to the electrical power utility company or does not threaten national security. Another analyst goal may include ensuring sensitive information is restricted to authorized individuals with the appropriate need-to-know status. In the illustrative example, the analyst performs a topical search to determine if any publicly available information poses a security threat. The analyst evaluates information available in single web page as well as aggregated information derived from a plurality of different web pages.

As described by process block 114, when performing a topical search the analyst defined terms are used to access the appropriate portions of the library. For the illustrative example, the analyst defined search terms include the words: increased targeting, electrical, power, infrastructure, utility, and security. In one embodiment, the method uses the analyst defined search terms to determine the appropriate class of terms. For the illustrative example, the classes of search terms include the “critical assets” class, the “facility capacities” class, and the “exposed/unprotected asset” class. Within each class grouping are a plurality of search terms. For the illustrative example, the analyst decides he is interested in the class referred to as “critical assets”. The search terms in the “critical assets” class include: “direct current”, “special protections system”, substation located, “control center” located, “major generating station” located, transformer back-up, and “critical loading” switchyard. The search terms within the quotation marks “” are exact word searches and the search terms without any quotation marks simply search for all the words identified.

The analyst may then decide to limit the search criteria as described by process block 120. The analyst then proceeds to remove the search term “direct current” and replaces it with the search term: “service area”, and “transfer station”. Thus, using the library and the limiting search criteria, the analyst generates an expanded search string that is subject to predefined limitations.

If the decision at diamond 112 is to perform a URL address search or web domain search, then the method proceeds to process block 124. In the URL address search a target URL address is identified. By way of example, the URL address is a web domain, a web site, or set of web locations. All the information within the target domain, web site, or web locations is gathered for analysis. As shown in process block 126, the analyst defined parameter for a URL search is at least one URL address that corresponds to an illustrative web site or a set of web locations. After the analyst inputs the URL information, the method then proceeds to process block 128 in which the limiting the search criteria for the web domain approach is performed. By way of example and not of limitation, the form of limiting search criteria for the web domain approach is to limit gathered information to web pages having particular domain extensions.

In an illustrative example, the analyst decides to apply the web domain approach to analyze a particular web site. In the illustrative example, the illustrative web site is the Pacific Northwest National Laboratory web site is located at “www.pnl.gov”. Additionally in the illustrative example, the analyst decides to limit the search to all web pages that link to the web pages located at the “www.pnl.gov” web site. A more detailed discussion of this illustrative embodiment is provided below.

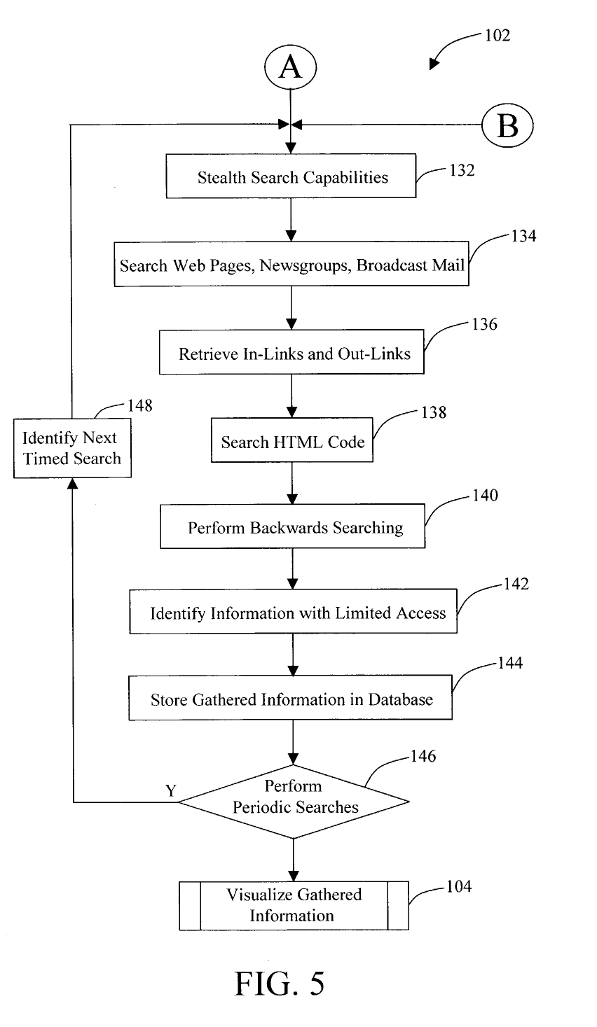

After performing the steps described above, both the topical search and web domain search methods converge to perform the various search steps described in FIG. 5. The search techniques identified in FIG. 5 take advantage of several innovative techniques such as stealth searches, retrieving in-links and out-links, searching HTML source code, backwards navigation, identifying restricted web pages that provide limited access, and performing historical searches. It shall be appreciated by those skilled in the art having the benefit of this disclosure that the analyst can perform one or more of the various search techniques described in FIG. 5.

In process block 132, the method permits the analyst to perform stealth searches. In an illustrative embodiment, the stealth searches are performed using an anonymous proxy server. An anonymous proxy server is a buffer between the analyst computer, i.e. client, and the server having the requested information. The anonymous proxy server does not transfer information about the analyst computer and effectively hides information about the analyst's surfing over the Internet. Any other embodiment that permits the analyst to remain anonymous can also be performed.

In process block 134, the method permits the analyst to search various portions of the Internet using one or more search engines. Typically, the search engine is configured to gather information from selected portions of the Internet, or from an Intranet. In an illustrative embodiment, during the information gathering phase, the analyst specifies how information should be “harvested” by selecting at least one search engine which “crawls” through the analyst selected portions of the Internet or Intranet. In an illustrative embodiment, a search is performed by searching web pages, newsgroup articles, and broadcast mail.

At process block 136, the analyst has the option of performing a reverse web searching procedure. Reverse web searching is a technique for gauging the popularity of a site, assessing its credibility, finding similar sites, and even uncovering hidden relationships that otherwise would escape notice. Reverse searching can be performed by identifying a plurality of out-bound links and a plurality of in-bound links. The out-bound links are collected by identifying links in a specified portion of the Internet or an Intranet. In an illustrative embodiment a web page's source code is scanned to identify all the HREF commands. The HREF command instructs a web browser to use a path that links an analyst selected web page to another web page. The in-bound links are collected by identifying information that links to a specified portion of the Internet or an Intranet. In an illustrative embodiment, the “link:” command from the Google search engine is used to identify the web pages that have links to a specified portion of the Internet or an Intranet. By way of example and not of limitation, the command “link:www.pnl.gov” identifies web pages that have links pointing to the Pacific Northwest National Laboratory homepage. Additionally, as described in further detail below, the collected out-bound links and in-bound links are also used to conduct statistical analysis that can be used to identify important web pages and generate a visual three-dimensional graphical layout of the link paths.

At process block 138, the analyst can also analyze the hypertext markup language (HTML) source code from a plurality of web sites or web pages. The HTML source code is analyzed because information can be embedded in the source code without the information being displayed on a web page. In an illustrative embodiment, the HTML source code is analyzed according to the search criteria identified by the analyst for either the URL based search or the topical search criteria.

At process block 140, the method permits backwards navigation for the topical search string approach. Backwards navigation provides a method for the finding of web pages that were not found by the search engine. Backwards navigation is an effective method for discovering links to pages that were not located by the search engine. By way of example and not of limitation, if a web page at “www.doe.gov/OPSEC/test/search.html” is found, then the analyst can delete the “search.html” phrase and navigate backwards to “www.doe.gov/OPSEC/test” and then remove/test to get the page “www.doe.gov/OPSEC/”.

At process block 142, the analyst has the option of identifying information on the Internet that provides limited or restricted access. Typically, the information with limited or restricted access requires a user name and a password. In an illustrative embodiment, the analyst identifies web sites and web pages that require a user name and password to access.

At process block 144, the information gathered from the Internet or an Intranet is stored in a database. By way of example and not of limitation, the database is a Microsoft Access database. Since the Internet is an evolving network of information, an analyst may decide to perform a historical analysis for a topical search or for a URL based search. Thus at decision diamond 146, the analyst has the option of deciding whether to perform periodic searches. If the decision at diamond 146 is made to periodically update the information gathered, then the method proceeds to process block 148. At process block 148 the analyst determines the frequency of searches to be performed and the timing for these searches. The analyst is informed about any changes to the database as a result of changes to the gathered Internet or Intranet information. In an illustrative embodiment, the searches are performed daily and the database is automatically updated to reflect changes to the gathered information. The analyst is automatically notified of any changes to the initially gathered information. The gathered information stored in the database then undergoes a “visualization” process as described in block 104.

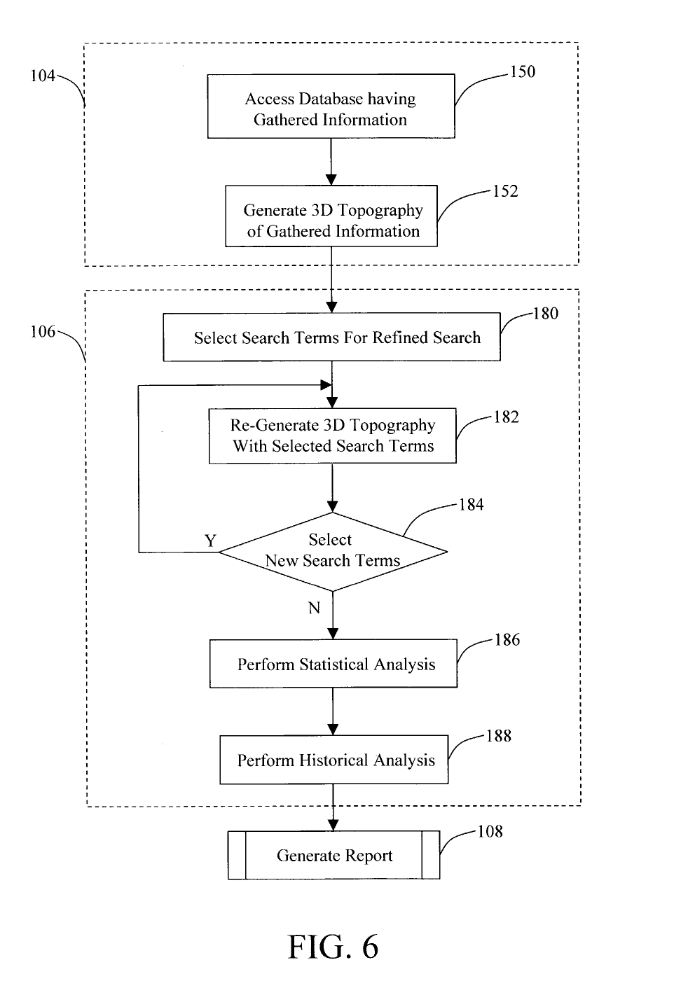

Referring to FIG. 6, there is shown a more detailed view of the visualization process 104 and the analysis process 106. At process block 150, the visualization process 104 accesses the database having the gathered Internet or Intranet information. In an illustrative embodiment, the gathered information in the database is accessed regularly due to potential changes to information in the Internet or Intranet.

The method then proceeds to process block 152 in which the gathered information stored in the database is used to generate a graphical two-dimensional (2D) or three-dimensional (3D) representation. The graphical representation is generated using the collected out-bound links and in-bound links described in process block 136. In an illustrative embodiment, a 3D topographic representation is generated with the gathered information stored in the database. For the 3D topographic representation, a three-dimensional graphic layout engine such as Open Inventor which is developed by Silicon Graphics, Inc. In the illustrative embodiment, the graphic layout engine first builds a topological data structure from input connectivity data, and then generates an optimal layout using a heuristic-guided force-directed layout algorithm. The resulting 3D topographic representation is then presented to the analyst for subsequent analysis that includes inspection and interaction. By way of example and not of limitation, different color schemes can be used to identify different types of web pages, different collection dates and different posting dates.

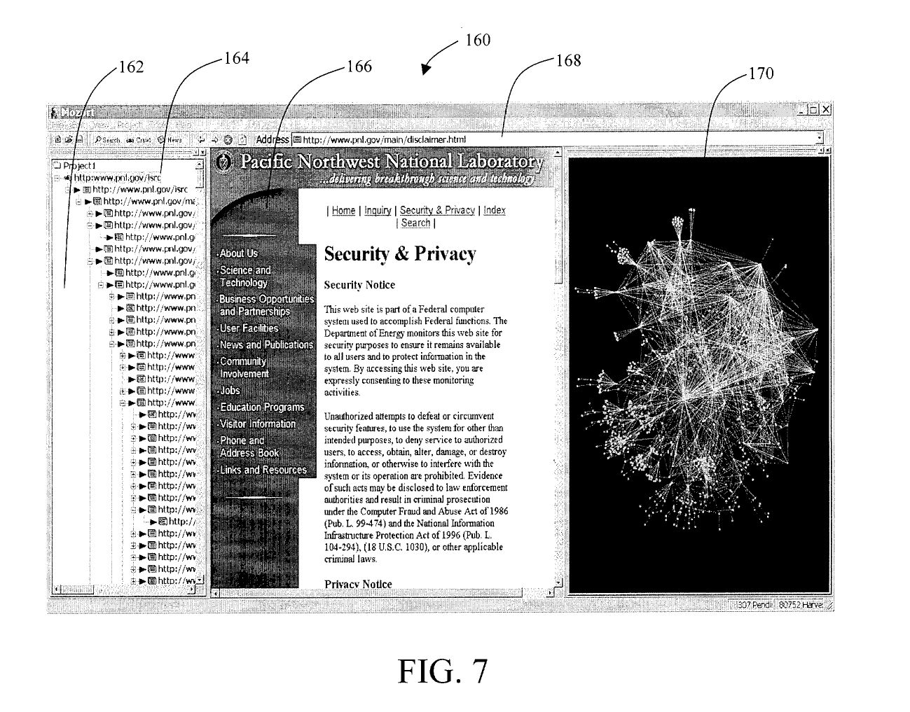

Referring to FIG. 7 there is shown a sample screen shot of an illustrative user interface in which a web domain search has been conducted and a 3D topographic representation has been generated. The illustrative user interface 160 includes a window 162 that shows a plurality web pages that are gathered after conducting the web domain search. The web domain search is conducted for the illustrative web address 164 which has the address “http://www.pnl.gov/lsrc”. Each web page that has either an in-bound link or an out-bound link the address 164 is identified. The process of identifying in-bound links and out-bound links is continued for all identified web pages. Since the process of finding in-bound links and out-bound links can easily reach exponential search proportions, there are typically limitations established. For the illustrative web address, the limitations are to identify all web pages having the web domain “pnl.gov” and to identify any “foreign web pages” that link to the “pnl.gov” web pages. For purposes of the illustrative example, the foreign web page is any web page that does not include the domain address “pnl.gov”.

The illustrative user interface 160 also includes a web page window 166 that shows a web page selected by the analyst. In one embodiment, the analyst can select the web page by simply moving the cursor control 16 over a web addresses in address window 164. In an alternative embodiment, the analyst can select the web page by double-clicking a selected web address. In the illustrative user interface 160, the address for the selected web page is displayed in address bar 168.

Adjacent the web page window 166 is a 3D topographic layout 170 of the gathered information. The hyperlink topographic layout 170 provides a great deal of information about the relative importance conferred on the web pages by the authors and by other persons. Analysis of such link topologies can reveal the presence and structure of so-called “web communities”. Web communities are collections of closely related web pages that reference one another and may be highly dynamic in nature. From an intelligence perspective, the ability to identify, characterize and monitor such web communities is of considerable value. The following articles, which are hereby incorporated by reference, provide further detail about hyperlink analysis: Kleinberg, J., 1998, “Authoritative Sources In A Hyperlinked Environment,” Pro. 9th ACM-SIAM Symposium on Discrete Algorithms; and Gibson, D., et al., 1998, “Inferring Web Communities From Link Topology,” Proc. 9th ACM Conference on Hypertext and Hypermedia.

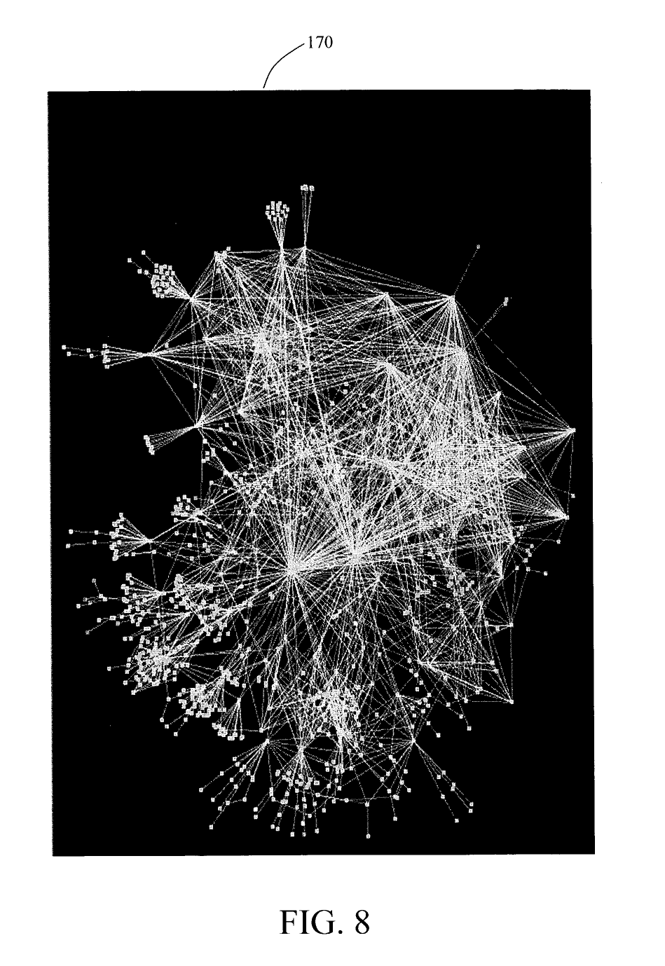

Referring to FIG. 8, there is shown a more detailed view of the hyperlink topographic layout 170. The web pages are identified by small squares and the hyperlinks are identified by the lines that connect the small squares together. In the illustrative embodiment, the web pages are color coded to assist in the subsequent analysis. By way of example and not of limitation, the web pages having links to the “pnl.gov” domain are shown as blue squares, the web pages having out-bound links that are generated by other government agencies are shown as green, web pages having out-bound links that are generated by the news media can be shown as orange, and web pages from foreign jurisdictions, e.g. not U.S. based web sites, with out-bound links to the pnl.gov web pages are colored red. Although FIG. 8 does not show the color coding for the web pages, it shall be appreciated by those of ordinary skill in the art having the benefit of this disclosure that the color coding can be easily implemented by evaluating the domain name extension or by conducting a “WHO IS” query at a domain registration web site.

Referring back to FIG. 6 there is also shown a more detailed view of the process step 106 for analyzing the gathered information. The process of analyzing gathered information takes advantage of the user interface 160. The user interface 160 provides support for a number of useful analytical procedures, including graphical selection and word search, as well as display zooming and scrolling operations, and generating a hyperbolic topographic layout of web hyperlinks. Additionally, in one embodiment the user interface 160 provides drag and drop directories to allow cross matrixing of different Internet or Intranet searches, detailed analysis of gathered information and the expansion of searches.

At process block 180, the method permits the analyst to perform a refined search using the topographic view of the gathered information. The purpose of the refined search is to generate a sub-set of information that can be more carefully analyzed by the analyst. During the refined search, the analyst determines whether certain information compromises sensitive, proprietary, or otherwise protected information. The goal of the security analyst is to identify sensitive information that may be used to support adversarial targeting of individuals, programs or information. During the performance of the refined search the analyst can perform a search using either the web domain approach or topical search approach described above. Alternatively, the methods used to perform a refined search can also be used to perform an expanded search in which the database having gathered information is supplemented with the results from the expanded search.

At process block 182, the method provides the analyst with the option of re-generating the topographic view of the results of the refined search. After analyzing the re-generated topographic layout generated from the refined search, the method proceeds to decision diamond 184. At decision diamond 184, the analyst has the option of deciding whether to select additional refined search terms to conduct another refined search. If the analyst decides to select additional search terms then the user interface 160 and the topographic layout is also updated.

At process block 186, the analyst then can perform statistical analysis on the gathered information stored in the database or on the refined search information. The statistical analysis is performed to help identify sensitive information. It shall be appreciated by those of ordinary skill in the art that well known statistical methods can be performed with the methods described here. By way of example and not of limitation, the statistical analysis includes the ranking of web pages using various well known methods.

At process block 188, the analyst determines whether a historical trend analysis is to be performed. Due to the dynamic nature of the Internet or an Intranet, it may be necessary to conduct a historical trend analysis to determine what changes occur to the gathered information as a function of time.

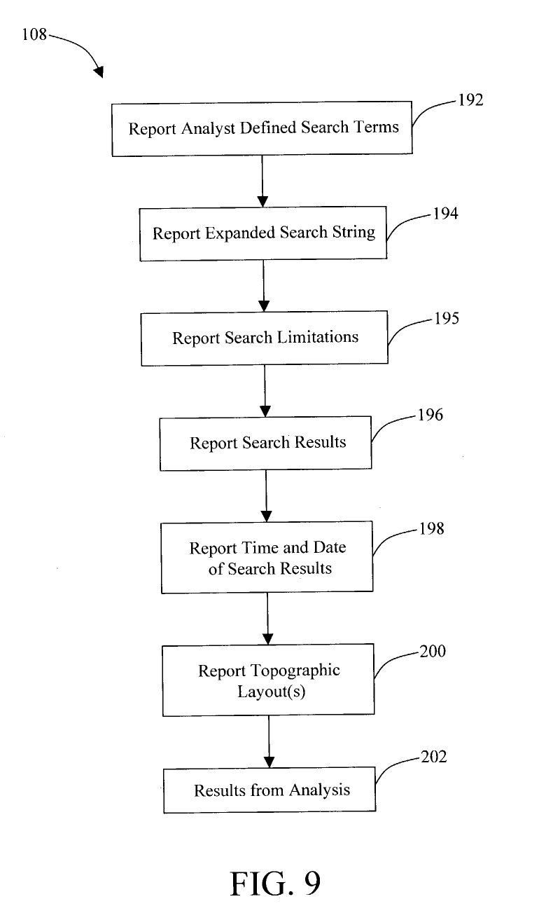

At process block 108, a report may then be generated. A more detailed view of the results that may be included in the report are shown in FIG. 9. In one embodiment, the analyst defined search terms are reported as shown in process block 192. Additionally for the topical search option, the expanded search string generated by using the library may also reported at block 194. At process block 195, the limitations used for the search are typically reported. The method then proceeds to process block 196 in which the results generated from the search engine are also typically reported. Should the analyst perform a historical analysis, then the time and date of the search results are also reported as shown in process block 198. At process block 200, the topographic layout of the gathered information is typically reported. Finally, the results from performing the analysis in process block 106 are also identified. It shall be appreciated by those of ordinary skill in the art that the report generated at process block 108 can vary according to the type of information the analyst determines is of significance to track and report.

A key benefit of the invention is its application flexibility: it may be used as a proactive, reactive, offensive, or defensive tool. From an intelligence perspective it can expose an unknown targeting or collection effort. In the business arena it can provide an insight into customer activities for marketing or outreach purposes. In support of information security efforts it can locate pieces of information related to the web page, web site or topic. And from a communications standpoint, the invention can provide an Internet demographic enabling a client to customize a web page to improve its ability to be found during subsequent searches, thus improving its visibility on the Internet.

Although the description above contains many specifications, these should not be construed as limiting the scope of the invention but as merely providing illustrations of some of the presently preferred embodiments of this invention. Thus, the scope of the invention should be determined by the appended claims and their legal equivalents rather than by the illustrative examples given.

What is claimed is:

1. A method for evaluating security threats from information available on the Internet or an Intranet, comprising;
gathering a plurality of information from the Internet or said Intranet using at least one analyst defined parameter;
generating a visual display of said plurality of information; and
analyzing said visual display and said plurality of information to identify a possible security threat.

2. The method of claim 1 wherein said at least one analyst defined parameter comprises a Uniform Resource Locator (URL).

3. The method of claim 1 wherein said at least one analyst defined parameter comprises a search string related to a topic.

4. The method of claim 1 wherein said plurality of information gathered from the Internet or said Intranet comprises at least one web page.

5. The method of claim 1 wherein said plurality of information gathered from the Internet or said Intranet comprises at least one posting from a newsgroup.

6. The method of claim 1 wherein said plurality of information gathered from the Internet or said Intranet comprises a broadcast e-mail.

7. The method of claim 1 wherein said plurality of information gathered from the Internet or said Intranet comprises at least one web page, at least one posting from a newsgroup and a broadcast e-mail.

8. The method of claim 1 further comprising storing said plurality of information in a database and any subsequent changes to said plurality of information.

9. The method of claim 8 wherein analyzing of said visual display and said plurality of information further comprises analyzing changes to said plurality of information.

10. The method of claim 1 wherein analyzing of said visual display and said plurality of Internet information further comprises,
performing a refined search of said plurality of information to identify a subset of information; and
analyzing said subset of information.

11. The method of claim 10 wherein said refined search is engaged with said analyst providing another URL.

12. The method of claim 10 wherein said refined search is engaged with another search string.

13. The method of claim 1 wherein said plurality of information gathered from the Internet or said Intranet is gathered with at least one search engine.

14. The method of claim 1 wherein gathering of said plurality of information further comprises permitting said analyst to limit said plurality of information gathered from the Internet or said Intranet.

15. The method of claim 1 wherein gathering of said plurality of information further comprises identifying a plurality of out-bound hyperlinks and a plurality of in-bound hyperlinks.

16. The method of claim 15 wherein analyzing said plurality of information further comprises performing a statistical analysis with said plurality of out-bound hyperlinks and said plurality of in-bound hyperlinks.

17. The method of claim 15 wherein generating of said visual display further comprises applying color coding to said plurality of out-bound hyperlinks and said plurality of in-bound hyperlinks.

18. The method of claim 15 wherein generating of said visual display further comprises generating a three-dimensional graphical layout of said plurality of out-bound hyperlinks and said plurality of in-bound hyperlinks.

19. The method of claim 1 wherein gathering of said plurality of information further comprises performing stealth searches for said plurality of information.

20. The method of claim 3 wherein gathering of said plurality of information further comprises performing backwards navigation for said search string related to said topic.

21. The method of claim 1 wherein gathering of said plurality of information further comprises identifying said plurality of information having limited or restricted access.

22. The method of claim 1 wherein analyzing said plurality of information further comprises performing a historical analysis of changes to said plurality of information.

23. A method for evaluating security threats from information available on the Internet or an Intranet, comprising;
gathering a plurality of information from the Internet or said Intranet using at least one analyst defined parameter;
generating a visual display of said plurality of information;
analyzing said visual display and said plurality of information to identify a possible security threat; and
reporting in an automated manner results from said analyzing of said visual display and said plurality of information.

24. The method of claim 1 wherein said plurality of information gathered from the Internet or said Intranet comprises at least one web page, at least one posting from a newsgroup and a broadcast e-mail.

25. The method of claim 24 wherein said at least one analyst defined parameter comprises a Uniform Resource Locator (URL).

26. The method of claim 24 wherein said at least one analyst defined parameter comprises a search string related to a topic.

27. The method of claim 24 further comprising storing said plurality of information in a database and any subsequent changes to said plurality of information.

28. The method of claim 27 wherein analyzing of said visual display and said plurality of information further comprises analyzing changes to said plurality of information.

29. The method of claim 24 wherein analyzing of said visual display and said plurality of Internet information further comprises,
performing a refined search of said plurality of information to identify a subset of information; and
analyzing said subset of information.

30. The method of claim 29 wherein said refined search is engaged with said analyst providing another URL.

31. The method of claim 24 wherein said refined search is engaged with another search string.

32. The method of claim 24 wherein said plurality of information gathered from the Internet or said Intranet is gathered with at least one search engine.

33. The method of claim 32 wherein gathering of said plurality of information further comprises permitting said analyst to limit said plurality of information gathered from the Internet or said Intranet.

34. The method of claim 32 wherein gathering of said plurality of information further comprises identifying a plurality of out-bound hyperlinks and a plurality of in-bound hyperlinks.

35. The method of claim 34 wherein analyzing said plurality of information further comprises performing a statistical analysis with said plurality of out-bound hyperlinks and said plurality of in-bound hyperlinks.

36. The method of claim 34 wherein generating of said visual display further comprises applying color coding to said plurality of out-bound hyperlinks and said plurality of in-bound hyperlinks.

37. The method of claim 34 wherein generating of said visual display further comprises generating a three-dimensional graphical layout of said plurality of out-bound hyperlinks and said plurality of in-bound hyperlinks.

38. The method of claim 34 wherein gathering of said plurality of information further comprises performing stealth searches for said plurality of information.

39. The method of claim 26 wherein gathering of said plurality of information further comprises performing backwards navigation for said search string related to said topic.

40. The method of claim 34 wherein gathering of said plurality of information further comprises identifying said plurality of information having limited or restricted access.

41. The method of claim 34 wherein analyzing said plurality of information further comprises performing a historical analysis of changes to said plurality of information.
